(19) United States
(12) Patent Application Publication
(10) Pub. No.: US 2011/0130091 A1
(43) Pub. Date: Jun. 2, 2011

(54) DEVICE FOR POWER AMPLIFICATION OF A PAYLOAD OF A MULTIBEAM SATELLITE FOR BROADCASTING DATA

(75) Inventors: Jacques SOMBRIN, Toulouse (FR); Jérôme PUECH, Ramonville (FR)

(73) Assignee: CENTRE NATIONAL D'ETUDES SPATIALES ( C.N.E.S.), Paris Cedex (FR)

(21) Appl. No.: 12/958,467

(22) Filed: Dec. 2, 2010

(30) Foreign Application Priority Data
Dec. 2, 2009 (FR) 0905817

(51) Int. Cl. H04B 7/185

(52) U.S. Cl. 455/13.4

(57) ABSTRACT

A device for power amplification of a payload of a multibeam satellite for broadcasting data, in which the circuits (10) for amplifying the data signals to be broadcast are connected to the broadcasting antennas (40, 41, 42, 43) by switches (12) and addition circuits (20, 25, 26, 27) making it possible to select a predetermined broadcasting configuration of the data signals. A satellite equipped with such an amplification device is also described.

The invention relates to a device for power amplification of a payload of a multibeam artificial satellite for broadcasting data, orbiting a planet—in particular the Earth, comprising:
a plurality of broadcasting antennas, each suitable to broadcast a data signal to be broadcast,
a plurality of power amplification circuits, each having an input receiving a data signal to be broadcast,
means for connection between the power amplification circuits and the antennas, these connection means being adapted to permit broadcasting, by the antennas, of the amplified signals delivered by the amplification circuits.

Such a satellite payload may be used, for example, for broadcasting multimedia content (audio and/or video, television programs, etc.) from a geostationary satellite to mobile terminals on the ground. For example, the plurality of broadcasting antennas may correspond to a plurality of linguistic zones to be covered.

The payload of such a multibeam broadcasting satellite must have a relatively high broadcasting power for each antenna. In particular, in the case of a geostationary satellite, the broadcasting power of the downlink is commensurately higher when the satellite is further from the ground, and when the receivers on the ground are mobile terminals. Typically, for a geostationary multimedia broadcasting satellite, the equivalent isotropically radiated power (EIRP) required is of the order of 60 to 72 dBW in 500 MHz per broadcasting antenna. Likewise, in the case of a multibeam satellite in medium or low orbit, it may also be useful to adapt the performances of the power amplification circuits to requirements, these being components whose bulk, weight and power consumption are relatively significant in the overall design of the satellite.

In order to optimize the use of the power available on board the satellite, it is considered necessary to be able to provide flexibility in the allocation of the on-board power as a function of the data signal or signals to be broadcast and the available antennas.

Thus, it may be necessary to broadcast a single data signal with the maximum available power on an antenna covering an extended zone, or to broadcast one or more signals with an adapted power on different antennas covering separate regions, or alternatively to be able to change over a given signal easily between two antennas, for example for maintenance requirements, etc.

In order to obtain the power flexibility mentioned above, it has been envisaged to integrate switches so as to direct the amplified signal to one or other of the broadcasting antennas (cf. for example U.S. Pat. No. 6,438,354). However, these switches must be capable of carrying out switching on a high-power radiofrequency signal. This is because a signal whose power corresponds to the entire broadcasting power of an antenna flows through each switch. Such components are very expensive, have a limited lifetime (the lifetime of an electronic component depending on its operating power) and because they are added specifically in the circuit of the payload (and therefore are not electronic components integrated and built in series simultaneously with the entire electronic circuit) they affect the general reliability of the payload. They may also introduce parasitic phenomena (arcs, breakdowns or inductive phenomena on switching, surface electron avalanche effects (“multipactor”), corona effects, transient oscillations, etc.) which are commensurately more significant when the transmitted power is higher. Furthermore, controlling them requires the use of filtering in order to avoid the propagation of transient intensity oscillations on switching. The presence of such filtering itself then induces a significant switching time and energy consumption. The use of switches operating at high power also inherently entails reduced dynamic performances in as much as the switching takes a longer time than in the scope of switching at low power, owing to the break in transmission during the switching.

In this context, it is an object of the invention to provide a device for power amplification of a payload of a multibeam satellite for broadcasting data, in which the broadcast power can be modified in realtime as a function of requirements, in particular by sending remote commands to the satellite.

It is in particular an object of the invention to provide such a power amplification device which offers great flexibility in the allocation of the on-board power with a relatively fine variation of the power levels, in particular less than the rated power of the on-board amplification device.

It is furthermore an object of the invention to permit switching of high-power signals between antennas without making it necessary to resort to special switches.

It is also more particularly an object of the invention to provide such a power amplification device which makes it possible to broadcast a given data signal on a plurality of different broadcasting antennas, the broadcasting power of the signal being distributed between these antennas.

It is also an object of the invention to provide such a power amplification device which is moreover compatible with its integration on board a satellite, in particular a geostationary satellite.

It is also an object of the invention to provide such a power amplification device whose design and manufacture are moreover simple, and which does not demand specifically designed steps as regards the power amplification device per se. More particularly, it is an object of the invention to provide such a power amplification device which can be made up of standard mass-produced circuits, the performance and reliability of which are well controlled.

To this end, the invention relates to a device for power amplification of a payload of a multibeam satellite for broadcasting data, comprising:
a plurality of broadcasting antennas, each suitable to broadcast a data signal to be broadcast,
a plurality of power amplification circuits, each having an input receiving a data signal to be broadcast,
means for connection between the power amplification circuits and the antennas, these connection means being adapted to permit broadcasting, by the antennas, of the amplified signals delivered by the amplification circuits,
   characterized in that the device comprises:
for each power amplification circuit, a switch having an input terminal connected to the output of the power amplification circuit, and at least two output terminals,
addition networks connecting at least one of the output terminals of each switch to a broadcasting antenna, each output terminal being connected to at most one addition circuit and each broadcasting antenna being connected to one and only one addition network, at least one addition network comprising at least one node connecting two input branches to an output branch, and
means for controlling the switches, adapted to operate said switches so that the two input branches of each node of an addition network are supplied simultaneously with an identical data signal having the same power.

Thus, in the device according to the invention, the switching of the amplified data signals is carried out immediately after the power amplification circuits, with a signal power level which does not require a special switch. As a function of the topology of the addition network to which the switches connect each amplification circuit, the elementary powers of the data signal amplified by each amplification circuit are added at each node of the network. This addition of the powers is made possible by the fact that the data signal arriving at each node is identical and has the same power on each of the input branches. The phenomena of attenuation and/or parasitic reflection of the data signal in the presence of an imbalanced node do not occur. The power delivered to the antenna depends on the number of ranks of nodes in the addition network.

Advantageously and according to the invention, the power amplification circuits are adapted to provide a power compatible with coaxial switches. It is thus possible to produce modules comprising a power amplification circuit and a switch, which are economical and easy to integrate into a satellite, in particular when using amplification circuits based on solid-state power amplifiers.

Advantageously and according to the invention, the power amplification circuits connected to a given addition network receive the same data signal as input. In combination with a system for distributing the data signal between the inputs of the amplification circuits, this characteristic makes it possible to broadcast the same signal or different signals on the various antennas.

Advantageously and according to the invention, the input branches of each node of an addition network are connected to the same number of amplification circuits. In this way, the power arriving at each node of an addition network is identical on each of the input branches and results in a doubled power in the output branch of the node.

Advantageously and according to the invention, the device of the invention has at least one addition network adapted for connecting all the amplification circuits to the same antenna. It is thus possible to direct all of the on-board power onto a single antenna by controlling the switches so as to connect all the power amplification circuits onto this network.

Advantageously and according to the invention, the addition networks are arranged so that in a first position of the switches all the amplification circuits are connected to the same antenna, and in a second position of the switches the amplification circuits are all connected in groups of decreasing size to antennas of corresponding power. This arrangement thus makes it possible to broadcast a given data signal either on a single antenna with a maximum power, or by means of a plurality of antennas, with powers adapted as a function of the regions to be covered.

Advantageously and according to the invention, the device has at least two identical addition networks, each connected to a broadcasting antenna, and the switches of the amplification circuits connected to these networks are adapted to permit changeover of the data signal to be broadcast from one antenna to the other. By virtue of this characteristic, the changeover of a high-power signal from a first broadcasting antenna to a second broadcasting antenna can be performed without using a high-power switch. This facilitates maintenance operations such as realigning an antenna of the pool of antennas on the satellite.

Advantageously and according to the invention, the input branches of each node are of equal length. This makes it possible to prevent the propagation times of the data signal from introducing phase shifts at the nodes, and degrading the duplication of the transmission power at them.

Advantageously and according to the invention, the means for controlling the switches are adapted to be controlled simultaneously by a switching command uploaded to the satellite. In this way, the reconfiguration of all or some of the payload of the satellite can be controlled remotely from a ground station.

The invention also extends to a multibeam satellite for broadcasting data, characterized in that it comprises at least one payload comprising at least one power amplification device according to the invention, supplying at least some of its broadcasting antennas.

The invention also relates to a power amplification device characterized in combination by all or some of the characteristics mentioned above or below.

Other objects, characteristics and advantages of the invention will become apparent from the following description and the appended drawings, in which:

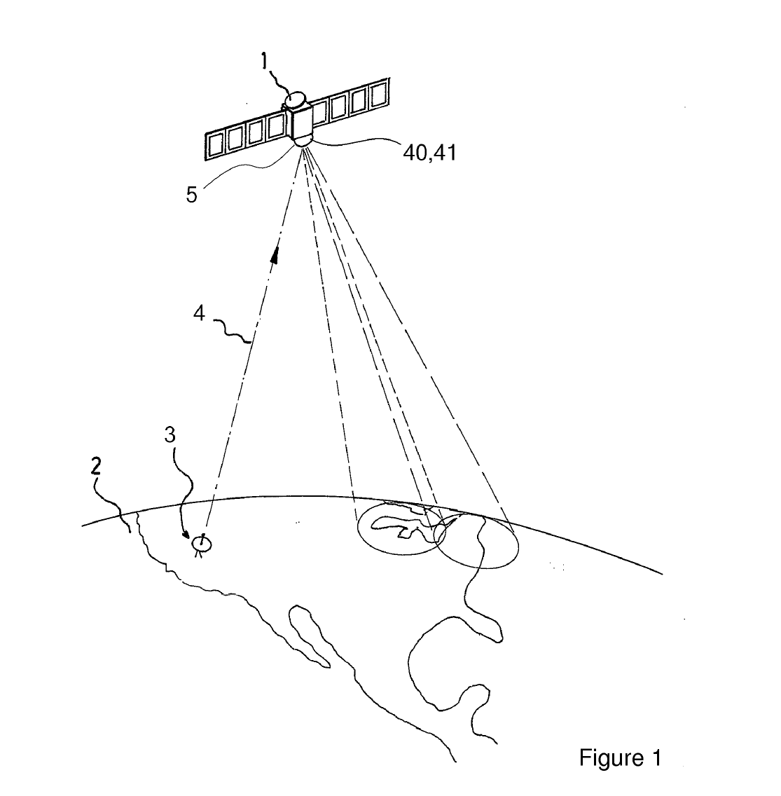

FIG. 1 is a schematic view of a satellite according to the invention,

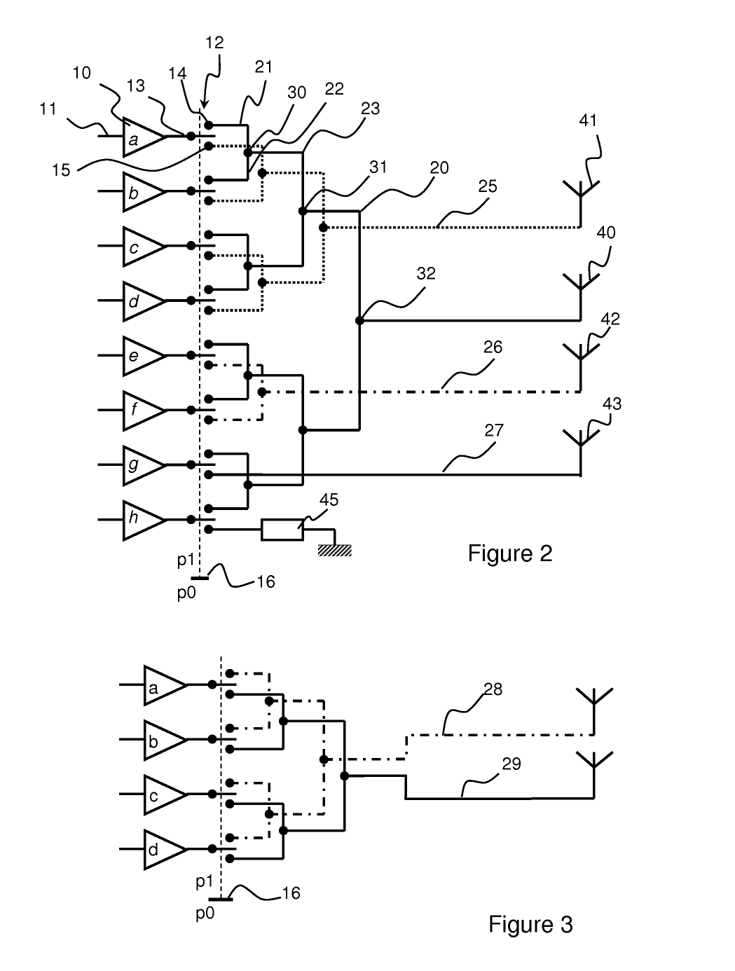

FIG. 2 is a general diagram of a satellite payload according to an embodiment of the invention,

FIG. 3 represents a variant of a power amplification device according to the invention, adapted to the switching of antennas,

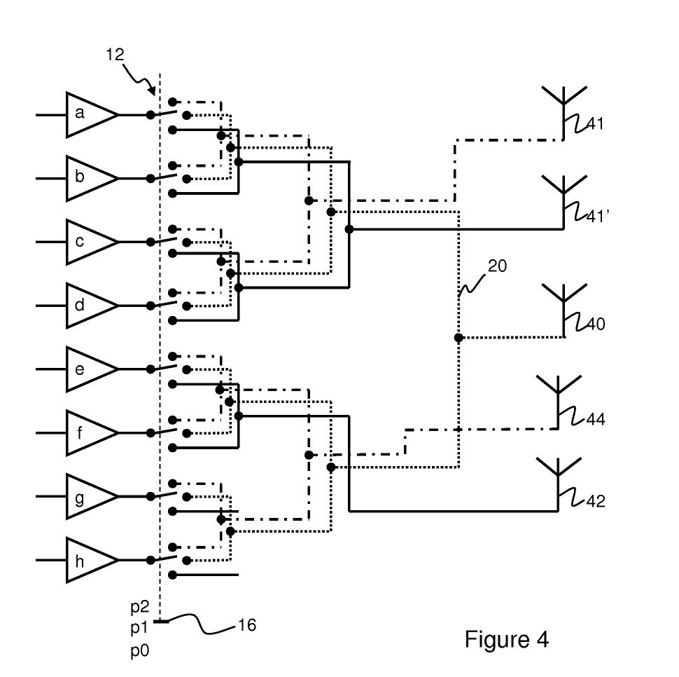

FIG. 4 represents an alternative embodiment of a power amplification device according to the invention, having extended switching possibilities.

FIG. 1 represents an example of a geostationary satellite 1 according to the invention, which is a multibeam satellite i.e. comprising a plurality of broadcasting antennas 40, 41 (specifically, just two broadcasting antennas in the example represented in this figure).

The data signals to be broadcast are transmitted from at least one ground station 3 via at least one uplink 4, the satellite 1 having at least one reception antenna (or beam) 5.

FIG. 1 represents merely one example, and it is to be understood that the invention applies to any other configuration, for example to each satellite of a constellation of satellites, to the case of multibeam satellites comprising a number of broadcasting antennas greater than 2, to non-geostationary satellites, etc.

The payload of a multimedia broadcasting satellite 1 compatible with the 3G standards comprises a plurality of broadcasting antennas, each covering a region, for example a country, and receives from the ground 2 digital data to be broadcast over various regions. These data are converted into a plurality of channels to be broadcast, each channel being amplified and delivered to a broadcasting antenna.

FIG. 2 represents an exemplary configuration of a power amplification device forming part of the payload of such a satellite and making it possible to broadcast a data signal to one or more coverage zones on the ground.

The power amplification device according to the invention has a plurality of power amplification circuits 10, denoted by a to h for example. A power amplification device preferably has 2ⁿ amplification circuits, n being a non-zero integer. Each amplification circuit 10 has a signal input 11 adapted to receive a data signal to be amplified, coming from prior signal reception and processing stages (not shown). The output of each amplification circuit 10 is connected to the input terminal 13 of a switch 12, which has at least two output terminals 14 and 15.

The amplification circuits 10 may be produced, depending on the frequency bands used, by means of travelling wave tubes providing an RF output power of between 50 and 500 W, or alternatively by means of solid-state (SSPA) amplification circuits providing an output power of between 10 and 90 W. Each amplification circuit 10 may consist of a single tube or SSPA circuit, or alternatively a plurality of tubes or circuits in parallel.

Advantageously, the output power of the amplification circuits 10 is selected so as to be compatible with coaxial switches 12, for example space-quality coaxial switches of the SPDT, DPDT, DP3T type, etc. marketed by the company RADIALL. Each pair comprising an amplification circuit 10 and a switch 12 may thus be combined in the form of a standard module allowing more economical fabrication and tests in series, and easy integration into a satellite.

For reasons of clarity in the drawing, the references relating to the amplification circuit 10 and the switch 12 have been applied only to the first amplification circuit denoted a and to the corresponding switch. In the text which follows, when it is necessary to distinguish between the elements of the different amplification circuits and switches, the general reference of the element will be used suffixed with the letter corresponding to the corresponding amplification circuit. Thus, for example, 14g denotes the output terminal 14 of the switch 12g associated with the amplification circuit 10g.

In the example represented in FIG. 2, the switches 12 are controlled by control means 16 making it possible to cause connection of the input terminal 13 to the output terminal 14 in a first position referenced by p1, and to the output terminal 15 in a second position referenced by p0. The control means 16 are adapted to control the switching of the switches 12 simultaneously.

The output terminals 14 and 15 of the switches 12a to 12h are connected to addition networks 20, 25, 26 and 27 connecting these output terminals of the switches to broadcasting antennas 40, 41, 42, 43. Each output terminal is connected to at most one addition network. Thus, for example, the output terminal 14a is connected only to the addition network 20.

Furthermore, each broadcasting antenna is connected to one and only one addition network. For example, the antenna 40 is only connected to the addition network 20 and likewise the antennas 41, 42 and 43 are respectively connected only to the addition networks 25, 26 and 27. Thus, each addition network connects one output terminal of one or a plurality of switches to one and only one broadcasting antenna.

The addition networks consist of conductive lines adapted to the frequency and power of the transported signal, and are produced in a manner known per se to the person skilled in the art by means of coaxial cables or waveguides, or a combination of the two.

Except for the line which connects the terminal 15h to a dissipative load 45, and the addition network 27 which connects the output terminal 15g of the switch 12g directly to the antenna 43, all the other addition networks have at least one node connecting two branches of the addition network, referred to as input branches, located between the output terminals of the switches and the node in question, to an output branch located between the node in question and the broadcasting antenna associated with the addition network.

Thus, the addition network 20 has a node 30 to which the input branches 21 and 22 are connected, coming respectively from the output terminals 14a of the switch 12a and 14b of the switch 12b. Starting from the node 30, an output branch 23 extends in the direction of the broadcasting antenna 40. It should be noted that this output branch 23 is also an input branch for the node 31 of the rank 2 in the addition network 20. The addition network 20 thus comprises seven nodes belonging to three different ranks, four nodes of rank 1 such as the node 30, two nodes of rank 2 such as the node 31 at which input branches coming from the nodes of rank 1 arrive, and one node 32 of rank 3 at which input branches coming from the nodes of rank 2 arrive and from which an output branch connected to the broadcasting antenna 40 departs. It should also be noted that the addition network 20 connects all the output terminals 14 of the switches 12 to the broadcasting antenna 40.

Similarly, the addition network 25 has two nodes of rank 1 and a single node of rank 2 connected to the broadcasting antenna 41, and the addition network 26 has only a single node of rank 1 connected to the broadcasting antenna 42. Thus, the input branches of each node of an addition network are connected to an identical number of amplification circuits 10, through one or more intermediate nodes. Therefore, if the amplification circuits 10 have the same output power, the data signal which supplies the input branches of a node will be identical and have the same power P on each branch, and the resulting signal on the output branch of the node will be an identical signal having a doubled power 2 P.

Thus, when the means 16 for controlling the switches are in position p1, all the input terminals 13 of the switches 12 are connected to the output terminals 14, which are themselves connected to the addition network 20. If all the amplification circuits 10a to 10h are supplied with the same data signal on their input 11, for example by means of a multiplexer (not shown), then the output signals of the amplification circuits will be identical and have a power P corresponding to the power delivered by an amplification circuit. At the output of each node of rank 1, the data signal therefore has a power 2 P. At the output of the nodes of rank 2, the data signal then has a power equal to 4 P, and at the output of the node 32 of rank 3, a data signal with a power equal to 8 P is ready to be broadcast by the broadcasting antenna 40.

Advantageously, the input branches of each node have an equal length so as to avoid phase shifts of the signal arriving at the node, due to different path lengths. This is because these possible phase shifts could be detrimental to the duplication of the power at this node and could lead to various undesirable effects, such as attenuations or heating of the node.

When the means 16 for controlling the switches are in position p0, all the input terminals 13 of the switches 12 are connected to the output terminals 15. In this case, according to the example represented in FIG. 2, the amplification circuits 10a to 10d are connected to the network 25 which makes it possible to deliver a data signal with a power of 4 P onto the broadcasting antenna 41, the amplification circuits 10e and 10f are connected to the network 26 which makes it possible to deliver a data signal with a power of 2 P onto the broadcasting antenna 42, and the amplification circuit 10g provides a signal with a power of P onto the broadcasting antenna 43.

More generally, an amplification device according to the invention having 2ⁿ amplification circuits may be connected to an addition network having n ranks of the nodes in order to deliver onto a broadcasting antenna a power equal to 2ⁿ times the elementary power of an amplification circuit, without thereby making use of special switches. In another control position of the switches, the data signal can be broadcast by n different broadcasting antennas with powers in stages of between 2⁰ P and 2ⁿ⁻¹ P.

Advantageously, by combining the amplification device according to the invention with a means for selectively supplying the inputs 11 of the amplification circuits 10, such as for example a multiplexer, the payload of a satellite may then be reconfigured in order to transmit a signal with a power corresponding to the entire on-board power or this same signal on n antennas corresponding to n zones to be covered, with powers staggered as a function of the zones or alternatively n different signals with powers staggered similarly. Specifically, it is then sufficient to provide a separate signal to each group of amplification circuits connected to a given addition network.

The example of FIG. 3 of the appended drawing presents a variant of the amplification device according to the invention, making it possible to switch the entire power delivered by the amplification circuits (here four circuits a, b, c and d) onto two different broadcasting antennas. To this end, the control means 16 are adapted to simultaneously control the switches associated with each amplification circuit so as to connect their output to one or other of two identical addition networks 28 and 29, each connected to a broadcasting antenna. In this way, the changeover of a data signal with a high power (depending on the number of amplification circuits of the device) from one antenna to another can be carried out without the need for a power switch.

The switches 12 are not of course limited to switches having one input and two outputs. In order to increase the versatility and the possibilities for reconfiguring the payload of the satellite, arrangement may be made as shown in FIG. 4 for the switches to have more than two outputs (for example three) and for the associated control means 16 also to have more than two positions. Thus, in the example of FIG. 4, when the control means are in an intermediate position p1, all of the available power of the amplification circuits a to h is routed to the broadcasting antenna 40 via the addition network 20, as in the case of FIG. 2. Furthermore, by driving the switching means from the position p0 to the position p2, the output power of the amplification circuits a to d is changed over between the broadcasting antennas 41 and 41′, and a broadcasting antenna 44 supplied by the amplification circuits e to h is put into service instead of the antenna 42 with a lower power, which was supplied only by the circuits e and f, etc.

Thus, the possibilities for reconfiguring a satellite are limited only by the number of possible positions of the switches and the topology of the addition networks which are associated with them, and of course by the available broadcasting antennas.

Advantageously, the reconfiguration possibilities may be controlled remotely by a control signal uploaded from the ground station 3 via the uplink 4. To this end, the control means 16 are adapted to be driven by an uploaded switching control signal. Preferably, the switches 12 and the addition networks are arranged so that, in a given amplification device, a single switching control signal leads to simultaneous switching of all the switches into the desired position. It is, however, also possible to arrange that each switch can be addressed individually by the uploaded control signal.

This description is of course given only by way of illustration, and the person skilled in the art may make numerous modifications to it without departing from the scope of the invention, for example forming the payload of the satellite with a plurality of amplification devices according to the invention, which are adapted to fulfill different and/or complementary missions.

1. A device for power amplification of a payload of a multibeam satellite for broadcasting data, comprising:
a plurality of broadcasting antennas, each suitable to broadcast a data signal to be broadcast,
a plurality of power amplification circuits, each having an input receiving a data signal to be broadcast,
means for connection between the power amplification circuits and the antennas, these connection means being adapted to permit broadcasting, by the antennas, of the amplified signals delivered by the amplification circuits,
characterized in that the device comprises:
for each power amplification circuit, a switch having an input terminal connected to the output of the power amplification circuit, and at least two output terminals,
addition networks connecting at least one of the output terminals of each switch to a broadcasting antenna, each output terminal being connected to at most one addition circuit and each broadcasting antenna being connected to one and only one addition network, at least one addition network comprising at least one node connecting two input branches to an output branch, and
means for controlling the switches, adapted to operate said switches so that the two input branches of each node of an addition network are supplied simultaneously with an identical signal having the same power.

2. The device as claimed in claim 1, characterized in that the power amplification circuits are adapted to provide a power compatible with coaxial switches.

3. The device as claimed in claim 1, characterized in that the power amplification circuits connected to a given addition network receive the same data signal as input.

4. The device as claimed in claim 1, characterized in that the input branches of each node of an addition network are connected to the same number of amplification circuits.

5. The device as claimed in claim 1, characterized in that it has at least one addition network adapted for connecting all the amplification circuits to the same antenna.

6. The device as claimed in claim 5, characterized in that the addition networks are arranged so that in a first position (p1) of the switches all the amplification circuits are connected to the same antenna, and in a second position (p0) of the switches the amplification circuits are all connected in groups of decreasing size to antennas of corresponding power.

7. The device as claimed in claim 5, characterized in that it has at least two identical addition networks, each connected to a broadcasting antenna, and in that the switches of the amplification circuits connected to these networks are adapted to permit changeover of the data signal to be broadcast from one antenna to the other.

8. The device as claimed in claim 1, characterized in that the input branches of each node are of equal length.

9. The device as claimed in claim 1, characterized in that the means for controlling the switches are adapted to be controlled simultaneously by a switching command uploaded to the satellite.

10. A multibeam satellite for broadcasting data, characterized in that it comprises at least one payload comprising at least one power amplification device as claimed in claim 1, supplying at least some of its broadcasting antennas.

11. The device as claimed in claim 2, characterized in that the power amplification circuits connected to a given addition network receive the same data signal as input.

12. The device as claimed in claim 2, characterized in that the input branches of each node of an addition network are connected to the same number of amplification circuits.

13. The device as claimed in claim 2, characterized in that it has at least one addition network adapted for connecting all the amplification circuits to the same antenna.

14. The device as claimed in claim 6, characterized in that it has at least two identical addition networks, each connected to a broadcasting antenna, and in that the switches of the amplification circuits connected to these networks are adapted to permit changeover of the data signal to be broadcast from one antenna to the other.
